(19) United States
(12) Patent Application Publication
(10) Pub. No.: US 2025/0358484 A1
(43) Pub. Date: Nov. 20, 2025

(54) Split Transport for Warping

(71) Applicant: Telefonaktiebolaget LM Ericsson (publ), Stockholm (SE)

(72) Inventors: Balázs Peter Gerö, Budapest (HU); András Kern, Budapest (HU); Bence Formanek, Budapest (HU); Dávid Jocha, Budapest (HU); Gabor Sandor Enyedi, Budapest (HU)

(21) Appl. No.: 18/866,722

(22) PCT Filed: May 26, 2022
(86) PCT No.: PCT/EP2022/064366

§ 371 Date: Nov. 18, 2024

(51) Int. Cl. H04N 21/63; G06T 3/18; G06T 7/73; G06T 15/00; G06T 15/20; H04N 21/81

(52) U.S. Cl. CPC H04N 21/631; G06T 3/18; G06T 7/73; G06T 15/005; G06T 15/205; H04N 21/816

(57) ABSTRACT

A network device (110) generates (810) video data representing a viewing frustrum of a three-dimensional scene. A plurality of virtual objects are within the viewing frustrum. The network device (110) transmits (820) pose information and the video data to a computing device (120) over a first transport channel (130a) and a second transport channel (130b), respectively. The first transport channel (130a) has lower latency characteristics than the second transport channel (130b) and the pose information comprises a pose of a virtual object within the viewing frustrum. The computing device (120) receives (860), from the network device (110), the pose information and video data over the first transport channel (130a) and the second transport channel (130b), respectively. The computing device (120) predicts (870) a newer pose of the virtual object from the pose information and generates (880) a two-dimensional image using the predicted pose and the video data as inputs to a warping function.

### TECHNICAL FIELD

The present disclosure generally relates to the field of network-supported rendering and, more particularly, to the use of transport channels having different performance characteristics in support of client-based warping techniques.

### BACKGROUND

On many display devices (particularly lightweight devices such as Head Mounted Displays (HMDs)), the lack of power and computational capacity often imposes significant limitations on the device's rendering capabilities. Other lightweight devices such as smartphones, extended reality (XR)/augmented reality (AR) devices, and the like can be similarly limited. Cloud-based rendering has been used to avoid limitations such as these at the display device. Cloud-based rendering typically shifts some of the computational rendering burden to a remote computer and requires transmission of video frames (often at high resolution) over a network, as well as a jitter buffer to compensate for network jitter.

Warping is a technique that allows new images to be rendered using information from previously computed views. Among other things, warping techniques can derive motion vectors of the virtual objects (e.g., from two-dimensional (2D) video frames of a three-dimensional (3D) scene) and use those motion vectors to predict the virtual object's future position and orientation. That said, some particular warping techniques presume that motion vectors derived from a series of images lack sufficient accuracy to generate images of sufficient quality and instead propose to derive motion vectors from rendering primitives.

Warping is a sufficiently established technique to have a specific extension in the OpenXR Rendering Application Programming Interface (API), which supports sending motion vectors downstream to an HMD to support space warps. Such motion vectors may be described by a plurality of surface points that can be followed in a sequence of images.

Although these various warping techniques are able to derive the position of virtual objects or image parts from downstream video frames, known warping techniques are prone to significant delay. For example, it takes time to stream and decode the video frames to the client. It is common for such delay to be, e.g., around 50 ms, as cloud rendering, downstream video transmission, jitter buffering, and derivation of motion vectors are all involved in the process.

The practicality of warping techniques is often significantly limited due to this delay. Significant delay often causes motion vectors to become outdated which deteriorates the accuracy of the predictions of virtual objects' positions and orientations. This delay may be especially impactful over wireless networks (e.g., Fifth-Generation (5G) networks) because such networks can be prone to higher amounts of network jitter relative to other types of networks. Although there are radio transmission techniques that provide ultra-low latency and high bandwidth at the same time, such techniques can be radio resource intensive and have significant scalability limits.

Other techniques attempting to alleviate the impact of this delay have proposed to generate graphics layers from 3D objects that include information from 3D simulation such as Z-layer information, speed, and direction of the motion of the 3D object. The graphics layers are encoded into the video stream and every video frame is a composite video frame of the graphics layers. The availability of this additional information can make motion vector prediction faster and less computationally intensive but delay nonetheless remains a significant impediment that frustrates the usefulness and efficacy of warping techniques in cloud-based rendering.

### SUMMARY

Embodiments of the present disclosure generally use different transport channels to transmit video data of a 3D scene and object information (e.g., pose information comprising a position and orientation of one or more virtual objects within the 3D scene). The different transport channels have significantly different Quality of Service (QOS) characteristics. A remote rendering server can produce the position and orientation data for the virtual objects along with synchronization info for synchronization of the pose information with rendered view frames. A bounded ultra-low latency transport option, such as Ultra-Reliable Low Latency Communications (URLLC), may be used to transport the virtual object information and a different transport, such as a low latency high bandwidth transport option, may be used to transport one or more video streams.

By selecting an ultra-low latency channel for the virtual object information, particular embodiments may ensure that pose data is more up-to-date at the client than in other AR remote rendering techniques as may be known in the prior art. Experimental estimates predict a latency gain of around 30-60 ms, which equates to approximately 2-3 frames in a 60 frames-per-second (FPS) display. Typically, rendering and encoding takes 10-20 ms, the downlink transport (assuming Low Latency, Low Loss Scalable Throughput (L4S)) takes 10-15 ms, and a 20-40 ms jitter buffer is maintained. In contrast, an URLLC downlink transport typically takes less than 5 ms. The gain in latency can result in more accurate pose predictions, which leads to a better AR experience. Additionally or alternatively, embodiments may support a bigger downstream budget for downstream video streaming without losing AR responsiveness as compared to existing techniques. As a result, overprovisioning the radio may advantageously be avoided.

Particular embodiments include a method of supporting cloud-based rendering implemented by a network device. The method comprises generating video data representing a viewing frustrum of a three-dimensional scene. A plurality of virtual objects are within the viewing frustrum. The method further comprises transmitting pose information and the video data to a computing device over a first transport channel and a second transport channel, respectively. The first transport channel has lower latency characteristics than the second transport channel and the pose information comprises a pose of a virtual object within the viewing frustrum.

In some embodiments, transmitting the pose information comprises transmitting the pose of the virtual object after transmitting the video data such that the pose of the virtual object is more current than the video data upon arrival at the computing device. In some such embodiments, transmitting the pose information further comprises transmitting, before the pose of the virtual object, an earlier pose of the virtual object. The earlier pose and pose of the virtual object correspond to motion of the virtual object within the viewing frustrum.

In some embodiments, the generating and transmitting is responsive to receiving a scene update notification from the computing device.

In some embodiments, the virtual object occludes an occluded virtual object that is within the viewing frustrum and the method comprises excluding the occluded virtual object from the pose information transmitted to the computing device. In some such embodiments, the method further comprises determining that the virtual object and the occluded virtual object mutually occlude each other and assigning a non-cyclic object occlusion relationship to the virtual object and occluded virtual object. The non-cyclic object occlusion relationship designates the virtual object as occluding the occluded virtual object without the occluded virtual object occluding the virtual object. The method further comprises excluding the occluded virtual object from the pose information in response to assigning the non-cyclic object occlusion relationship. In some embodiments, additionally or alternatively, the virtual object occludes the occluded virtual object together with one or more other virtual objects within the viewing frustrum.

In some embodiments, the pose information further comprises a further virtual object within the viewing frustrum and the method further comprises assigning the virtual object and the further virtual object to different layers of the video data. The method further comprises generating the video data comprises generating a respective video stream for each of the different layers. In some such embodiments, the method further comprises assigning an additional virtual object within the viewing frustrum to a same layer as the virtual object responsive to the virtual object and the additional virtual object having disjoint bounding boxes. In some embodiments, the pose information further comprises a camera pose corresponding to the viewing frustrum.

In some embodiments, the method further comprises transmitting a speed and/or acceleration of the virtual object over the first transport channel.

In some embodiments, the method further comprises including the pose of the virtual object in the pose information responsive to determining that the pose of the virtual object has changed.

In some embodiments, the method further comprises excluding a pose of a non-moving virtual object within the viewing frustrum from the pose information.

Other embodiments include a method of generating a two-dimensional image of a three-dimensional scene implemented by a computing device. The method comprises receiving, from a network device, pose information and video data over a first transport channel and a second transport channel, respectively. The video data represents a viewing frustrum of a three-dimensional scene. The first transport channel has lower latency characteristics than the second transport channel. The pose information comprises a pose of a virtual object within the viewing frustrum, the pose being more current than the video data. The method further comprises predicting a newer pose of the virtual object from the pose information and generating a two-dimensional image using the predicted pose and the video data as inputs to a warping function.

In some embodiments, generating the two-dimensional image using the predicted pose and the video data as inputs to the warping function comprises warping a bounding box of the virtual object based on the predicted newer pose.

In some embodiments, the video data comprises a plurality of video streams, each video stream corresponding to a respective layer of the scene. The virtual object and a further virtual object within the viewing frustrum are assigned to different layers of the scene. In some such embodiments, the method further comprises using a pose of the further virtual object to generate an earlier two-dimensional image of the scene before receiving the pose information and the video data and to generate, along with the pose information and the video data, the two-dimensional image of the scene in response to the further virtual object remaining stationary since generating the earlier two-dimensional scene. In some embodiments, additionally or alternatively, generating the two-dimensional image further comprises warping an image frame comprising the virtual object and the further virtual object based on a camera pose corresponding to the viewing frustrum.

Other embodiments include a network device comprising processing circuitry and interface circuitry communicatively connected to the processing circuitry. The processing circuitry is configured to generate video data representing a viewing frustrum of a three-dimensional scene. A plurality of virtual objects is within the viewing frustrum. The processing circuitry is further configured to transmit pose information and the video data to a computing device via the interface circuitry over a first transport channel and a second transport channel, respectively. The first transport channel has lower latency characteristics than the second transport channel and the pose information comprises a pose of a virtual object within the viewing frustrum.

In some embodiments, the processing circuitry is further configured to perform any of the methods implemented by a network device described above.

Yet other embodiments include a computer program comprising instructions that, when executed on processing circuitry of a programmable network device, cause the processing circuitry to carry out any of the methods implemented by a network device described above.

Still other embodiments include a carrier containing such a computer program. The carrier is one of an electronic signal, optical signal, radio signal, or computer readable storage medium.

Other embodiments include a computing device comprising processing circuitry and interface circuitry communicatively connected to the processing circuitry. The processing circuitry is configured to receive, from a network device, pose information and video data over a first transport channel and a second transport channel, respectively. The video data represents a viewing frustrum of a three-dimensional scene. The first transport channel has lower latency characteristics than the second transport channel. The pose information comprises a pose of a virtual object within the viewing frustrum, the pose being more current than the video data. The processing circuitry is further configured to predict a newer pose of the virtual object from the pose information and generate a two-dimensional image using the predicted pose and the video data as inputs to a warping function.

In some embodiments, the processing circuitry is further configured to perform any of the methods implemented by a computing device described above.

Yet other embodiments include a computer program comprising instructions that, when executed on processing circuitry of a programmable computing device, cause the processing circuitry to carry out any of the methods implemented by a computing device described above. Still other embodiments include a carrier containing such a computer program. The carrier is one of an electronic signal, optical signal, radio signal, or computer readable storage medium.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter according to one or more embodiments, whereas discussion of a specific instance of an illustrated element will append a letter designation thereto (e.g., discussion of a transport channel 130, generally, as opposed to discussion of particular instances of transport channels 130a, 130b).

FIG. 1 is a schematic block diagram illustrating an example network environment, according to one or more embodiments of the present disclosure.

FIG. 2 is a schematic block diagram illustrating an example processing flow between a network device and a computing device, according to one or more embodiments of the present disclosure.

FIG. 3 is a timing diagram illustrating example signaling between a network device and a computing device, according to one or more embodiments of the present disclosure.

FIG. 4 is a flow diagram illustrating an example method of supporting cloud-based rendering implemented by a network device, according to one or more embodiments of the present disclosure.

FIG. 5 is a flow diagram illustrating an example rendering method implemented by a network device, according to one or more embodiments of the present disclosure.

FIG. 6 is a flow diagram illustrating an example method of assigning virtual objects to a given layer implemented by a network device, according to one or more embodiments of the present disclosure.

FIG. 7 is a flow diagram illustrating an example method of determining information to transmit over a lower latency transport channel implemented by a network device, according to one or more embodiments of the present disclosure.

FIG. 8 is a flow diagram illustrating an example method of generating a two-dimensional image of a three-dimensional scene implemented by a computing device, according to one or more embodiments of the present disclosure.

FIG. 9 is a flow diagram illustrating an example method implemented by a network device, according to one or more embodiments of the present disclosure.

FIG. 10 is a flow diagram illustrating an example method implemented by a computing device, according to one or more embodiments of the present disclosure.

FIG. 11 is a schematic block diagram illustrating an example network device, according to one or more embodiments of the present disclosure.

FIG. 12 is a schematic block diagram illustrating an example computing device, according to one or more embodiments of the present disclosure.

### DETAILED DESCRIPTION

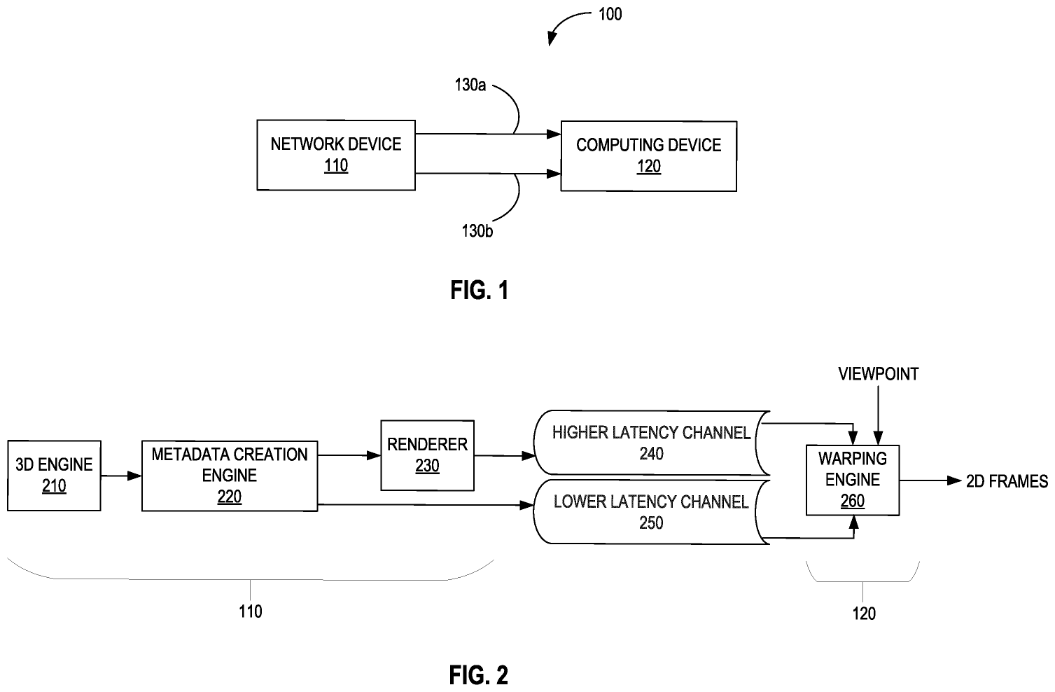

FIG. 1 is a schematic block diagram that illustrates an example networking environment 100 comprising a network device 110 and a computing device 120. The network device 110 is a server (e.g., a cloud server) that communicates with one or more clients via a communication network, e.g., to provide data and/or services. The computing device 120 is a client of the server and, in this regard, communicates with the network device 110 via the network. Examples of the computing device 120 include a workstation, desktop computer, laptop, XR device, AR device, mixed reality (MR) device, HMD, smartphone, tablet computer, and/or the like.

The network device 110 provides different data to the computing device 120 via different transport channels 130. The different transport channels 130 are designed to have different performance characteristics (e.g., different latency, bandwidth, and/or jitter). For example, the different channels 130 may include a first transport channel 130a and a second transport channel 130b, the first transport channel 130a having lower latency characteristics than the second channel 130b. According to one such example, the first channel 130a is a URLLC channel and the second channel 130b is an LAS channel.

Although other examples may include additional channels or different channels from the ones described above, the examples below may refer to a lower latency channel and a higher latency channel solely to simplify explanation. The characteristics of the channels may be different according to different embodiments, e.g., in order to optimize the split transport solutions proposed herein for different performance requirements. It should not be presumed that, in all embodiments, the higher latency channel is necessarily a “worse” or lower quality channel. On the contrary, the higher latency channel may have other characteristics that are superior to the lower latency channel in one or more respects. For example, in some embodiments the higher latency channel may have higher bandwidth available. It should also not be presumed that in all embodiments the lower latency channel is necessarily only higher performing in a single respect. For example, in some embodiments, the higher latency channel may also have lower packet loss than the lower latency channel (or vice versa, as may be appropriate for the particular embodiment).

FIG. 2 is a flow diagram illustrating an example data processing flow in which data is generated, transported from the network device 110 to the computing device 120, and used at the computing device 120. Each of the elements illustrated within the network device 110 and the computing device 120 may be a software element executing on programmable processing circuitry, special-purpose processing circuitry, or a combination of hardware and software components of their respective devices 110, 120.

As shown in the example of FIG. 2, the network device 110 comprises a 3D engine 210, a metadata creation engine 220, and a renderer 230. The 3D engine 210 provides information about a 3D scene to the metadata creation engine 220. The metadata creation engine 220 extracts, from the 3D scene information, metadata regarding virtual objects within a viewing frustrum. The viewing frustrum is a region of space within the 3D scene intended for display at the computing device 120 (e.g., on a display device comprised within or attached to the computing device 120).

Based on the information extracted from the 3D scene, the metadata creation engine 220 sends object information (e.g., pose information) to the computing device 120 via a lower latency channel 250. The pose information comprises, for each of one or more virtual objects in the 3D scene, a position and an orientation of the virtual object. According to certain preferred embodiments, the pose information is not relative to the camera pose (though the embodiments discussed herein are not necessarily limited in this respect). That is, the pose information may be global pose information that is independent of the viewing frustrum (e.g., in the form of coordinate data).

The metadata creation engine 220 also triggers rendering for the 3D scene as needed, e.g., in parallel to object information processing. To trigger this rendering, the metadata creation engine may, e.g., send a control signal to the renderer 230. The renderer 230 may, in response, process information regarding the 3D scene and send video data to the computing device 120 via the higher latency channel 240 (e.g., in the form of one or more video streams). By providing virtual object pose information via the lower latency channel 250 (e.g., rather than the higher latency channel 240), pose information for the one or more virtual objects of the 3D scene may be suitably up-to-date for use by a warping engine 260 of the computing device 120. The warping engine 260 may thus perform pose prediction for the one or more virtual objects that advantageously uses warping techniques to produce 2D images of the 3D scene at generally higher quality relative to traditional methods. This higher quality may be reflected in objects that are warped more accurately and/or realistically within the 2D images presented on a display relative to alternative solutions.

The warping engine 260 uses the pose information and the video data, along with viewpoint information corresponding to the viewing frustrum, to generate 2D frames for display on a display device. Given that the lower latency channel 250 has lower latency than the higher latency channel 240, the pose information may be expected to be generally more up-to-date than the video data. Correspondingly, the video data may experience more delay than the pose information given the different characteristics of the different transport channels 240, 250.

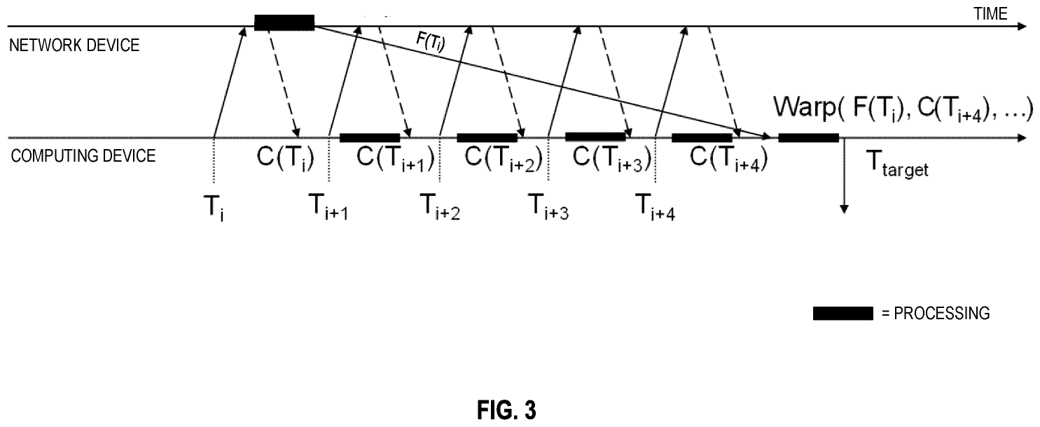

FIG. 3 is a timing diagram illustrating a representative example of when certain events occur in the process described above with respect to FIG. 2. In particular, FIG. 3 shows events associated with different times T at increments Tᵢ through Tᵢ₊₄. Pose information (including, e.g., coordinates representing the position and/or orientation of one or more virtual objects) associated with a given time T are given by C(T). Video frames associated with a given time T are given by F(T). Upper timeline denotes events at the network device 110 whereas the lower timeline denotes events at the computing device 120 as time elapses from left to right.

In general, the computing device 120 periodically sends environment update requests to the network device 110, and the network device 110 responds with pose information and video frames. As discussed above, the pose information and video frames are sent to the computing device 120 over different transport channels 130. Thus, pose information provided by the network device 110 in response to the environment update message sent by the computing device 120 at time Tᵢ arrives relatively quickly (i.e., before time Tᵢ₊₁). In contrast, a 2D video frame timestamped at Tᵢ (i.e., F(Tᵢ)) does not arrive at the computing device 120 until after Tᵢ₊₄. Each environment update request may include camera pose information for use by the network device 120 in rendering a corresponding video frame. After both pose and video information have arrived at the computing device 120, the computing device applies a warp function that operates on the latest video frame and the most recent pose. In this example, the computing device receives five pose information updates (C(Tᵢ), C(Tᵢ₊₁), C(Tᵢ₊₂), C(Tᵢ₊₃), and C(Tᵢ₊₄)) within the time it takes to receive a single video frame F(Tᵢ). The relative delay in receiving the video frame F(Tᵢ) is not only due to the pose information being sent over a lower latency channel 250, but also due to the additional rendering time required before the video frame information can be sent by the network device 120. Indeed, as shown in FIG. 3, the pose information can be sent in parallel with the rendering process because the poses are available in the network device 110 soon than the rendered video frames. Moreover, the frames may require encoding, transmission, jitter buffering and decoding, each of which may also increase the delay in sending the frame data. Because the computing device 120 has more up-to-date poses, the computing device 120 is able to perform more accurate warping.

It should also be noted that particular embodiments such as those exemplified by FIG. 3 support pose updates that occur more frequently than the video frame rate. Thus, embodiments of the present disclosure may continue to work advantageously by providing pose information updates even when the video frame rate is reduced (e.g., by network capacity limitations).

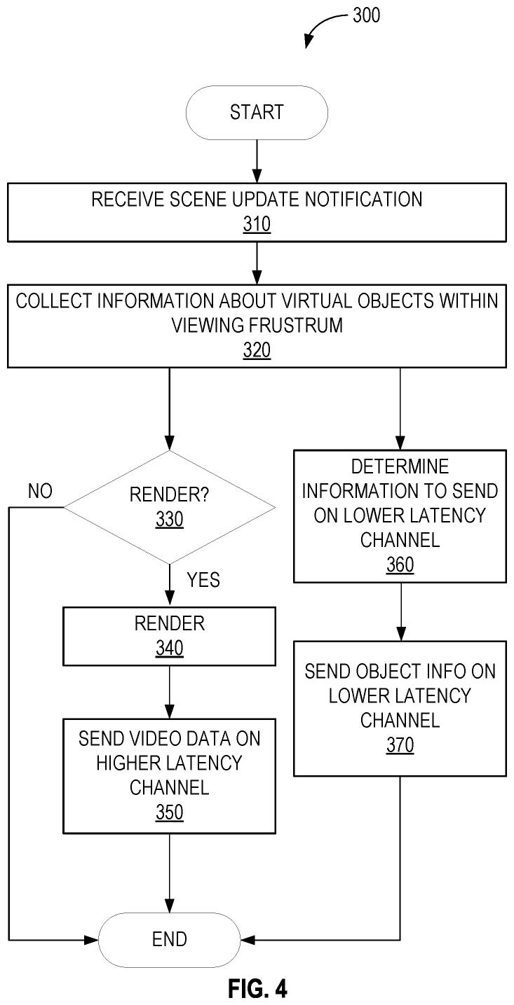

In view of the examples above, FIG. 4 illustrates an example method 300 implemented by a network device 110. In this example, the method 300 comprises receiving a scene update notification (step 310). This scene update notification may be received each time the 3D scene is updated. For example, a user of the computing device 120 may provide input that moves the camera position or a virtual object within the camera's viewing frustrum and, in response, the computing device 120 sends a notification to the network device 110 indicating that the scene has been updated. In this regard, the 3D scene may, for example, be updated by a physics simulation engine provided by a game server. It should be noted that the network device 110 may serve multiple client devices, in which case the method 300 may be invoked separately for each client device interacting with the network device 110 as described herein.

The method 300 further comprises collecting information about virtual objects that lie within the viewing frustrum of a given camera position (block 320). This information may, in particular, be collected by the metadata creation engine 220 discussed above. The collected information may include pose information for each of the virtual objects, for example. This pose information may include coordinates identifying a position and/or orientation of the virtual object.

The method 300 further comprises determining whether or not to render in response to the scene update notification (block 330). This determination may, for example, be based on a configuration of the network device 110. For example, the network device 110 may be configured to initiate rendering in response to every n-number of update notifications from a given computing device 120. In one particular example, the network device 120 determines that rendering is needed responsive to every other update notification received.

If the network device 120 determine to render (block 330, yes path), the network device 110 performs rendering (block 340) and sends video data produced by the rendering process on a higher latency channel 240 to the computing device 120 (block 350). Particular examples of rendering processes will be discussed in further detail below. If the network device 120 determines not to render (block 330, no path), the network device 110 refrains from rendering and sending video data to the computing device 120 in response to the scene update notification.

To the extent that rendering related tasks (blocks 330, 340, and 350) are performed, said tasks are performed in parallel with processing (blocks 360 and 370) related to sending other information to the computing device 120 via a lower latency channel 250. This other information may include object information relating to the pose of one or more virtual objects and, optionally, other attribute information. This other attribute information may, for example, include a timestamp of the 3D scene update notification and/or other attributes of the virtual objects useful for describing motion (e.g., a speed and/or acceleration of one or more of the objects).

Thus, the network device 110 determines what information to send on the lower latency channel 250 (block 360) and, in response, sends at least object information for one or more virtual objects to the computing device 120 via the lower latency channel 250 (block 370). Particular examples of determining what information to include on the lower latency channel 250 will be discussed in further detail below. At the computing device 120, virtual object identifiers may be used to match the object information received over the lower latency channel 250 to the video data received via the higher latency channel 240. Said virtual object identifiers may be transmitted on either or both the channels 240, 250 for this purpose.

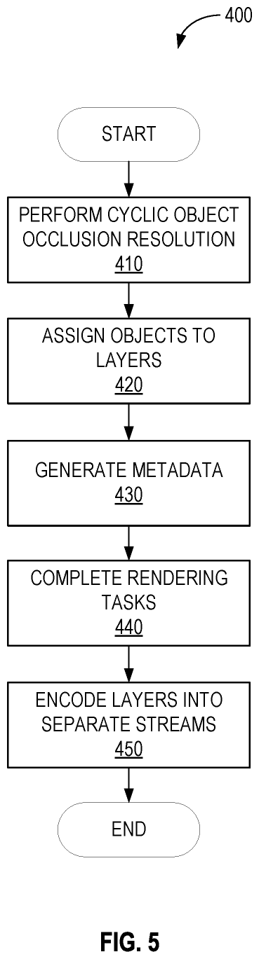

FIG. 5 is a flow diagram illustrating an example method 400 of rendering implemented by a network device 110 in accordance with particular embodiments of the present disclosure (e.g., as part of the rendering discussed above with respect to FIG. 4, block 340). In this example (and as will be explained in greater detail below), the rendering takes into consideration that virtual objects within the viewing frustrum may, in fact, occlude each other depending on the pose of the virtual objects and camera. Objects that are occluded by other objects may not need to be rendered.

In considering occlusion between objects, cyclic occlusion is a special case of occlusion that may require special handling. Non-cyclic occlusion involves scenarios in which occlusion is unidirectional. That is, one object is in front of and occludes another object, which may occlude another object, and so on. However, there are occasions where, for example, a first object occludes a second object and the second object occludes the first object. An example of such a circumstance may be a depiction of a pair of folded hands (e.g., with fingers interlocked). More complex examples may include relationships in which object A occludes object B which occludes object C which, in turn, occludes object A. Under circumstances in which cyclic occlusion occurs, the renderer may need to perform special processing to understand which of the objects, if any, need to be rendered and which ones, if any, do not.

Accordingly, the rendering method 400 comprises performing cyclic object occlusion resolution (block 410) to determine which virtual objects involved in cyclic occlusion need to be rendered. In this regard, cyclic objection occlusion resolution may comprise identifying a plurality of virtual objects within the viewing frustrum that are in a cyclic object occlusion relationship with each other and assigning a non-cyclic occlusion relationship to those virtual objects.

For example, cyclic object occlusion resolution for two objects that occlude each other may include selecting either one of the objects to be treated as being above the other. Pixels of the “lower” object are then occluded by the “higher” object. The pixels of the “higher” object do not need to be changed. Note that this example resolution algorithm can be used to break cyclic occlusion in cycles that involve several objects.

In this way, cyclic occlusion resolution may be kept simple by defining an artificial unidirectional relation between objects having a cyclic occlusion relationship. To do so, cyclic object occlusion resolution may simply apply a rule that will treat one object as occluding the other, even though they actually mutually occlude each other in the scene. Said rule may use any repeatable criteria. For example, the object that is occluded or occluding may be whichever has the higher or lower object identifier. Other rules for assigning the non-cyclical relationship between the virtual objects are myriad but are generally supported by the embodiments described herein.

In this example, the rendering method 400 further comprises assigning the virtual objects to layers (block 420). The image layers are used to represent occlusion information. Thus, the virtual objects are mapped to layers such that higher layer objects (e.g., an object assigned to layer 1) does not occlude lower layer objects (e.g., an object assigned to layer 3). Consequently, blending the layers to a single image may be performed simply, e.g., by putting the layers on top of each other (e.g., with layer 1 at the top). More detailed examples of how objects may be assigned to layers in accordance with particular embodiments of the present disclosure will be explained in further detail below.

After mapping the objects to layers, the network device 110 generates metadata that will be sent over the lower latency channel 250 (block 430). This metadata may include information describing the virtual objects, e.g., where the objects are located (in the form of coordinates and/or dimensions), virtual object identifiers, frame identifiers, layer identifiers, bounding box descriptors (e.g., coordinates of a corner of a bounding box containing the virtual object and a width and height of the bounding box). The metadata may additionally or alternatively include camera pose information as may be known to the network device 110 at the time of receiving the 3D scene update notification.

After the metadata has been generated, the network device 110 may complete one or more further rendering tasks, e.g., applying shading information, textures, lighting, pixel manipulation, and/or other such tasks as may be desired (block 440).

Once the rendering tasks are complete, the network device encodes each layer into a separate video stream (block 450). The separate video streams are sent to the computing device 120 via the higher latency channel 240, as discussed above.

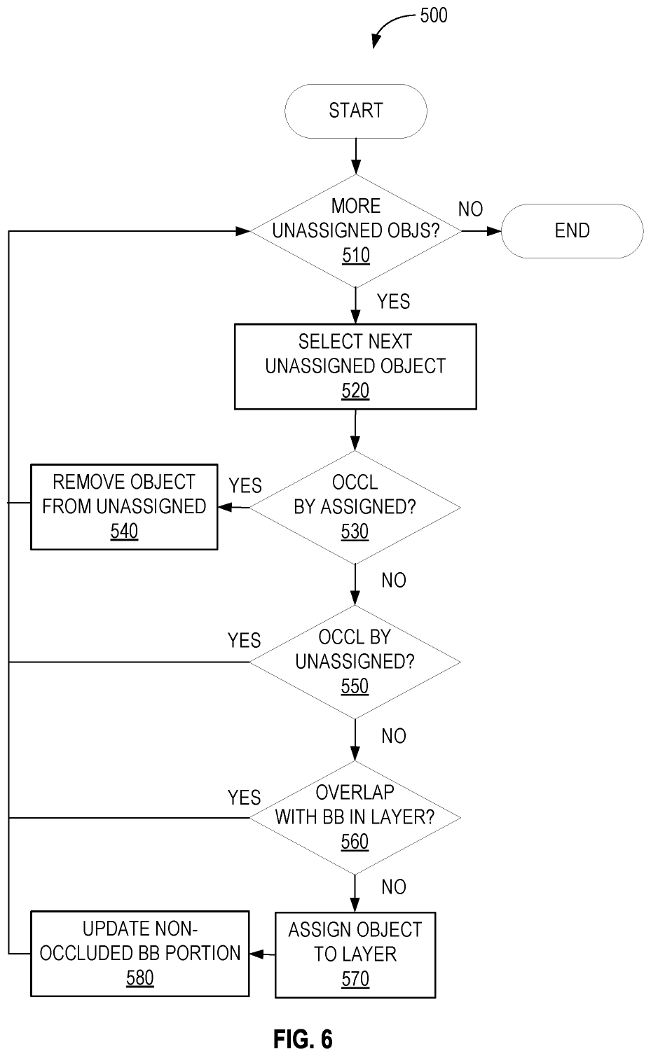

FIG. 6 is a flow diagram illustrating an example method 500 of assigning virtual objects to a given layer implemented by a network device 110 in accordance with one or more embodiments of the present disclosure (e.g., as part of the layer assignment discussed above with respect to FIG. 5, block 420). The method 500 comprises iterating through unassigned objects (block 510, yes path) and determines whether the unassigned objects can be assigned to the current layer. Once all of the unassigned objects have been evaluated (block 510, no path), the method 500 ends.

To determine whether the unassigned objects can be determined to the current layer, the network node 110 selects the next unassigned object to evaluate (block 520). The network node 110 determines whether the object is fully occluded by objects already assigned to layers and, if so (block 530, yes path), the object is removed from the list of unassigned objects (block 540). In some embodiments, an object is considered fully-occluded if the non-alpha (i.e., non-transparent) components of lower layers completely overlap with the object. That said, in other embodiments, the non-alpha components are alternatively reduced by a given margin so that objects remain in the loop that might become visible when the frame is warped. It should be noted that an object may not be fully occluded by higher layer objects but may nonetheless be partially occluded by said higher layer objects and remain in consideration for potentially being assigned to the current layer or lower.

If the object is not fully-occluded by already assigned objects (block 530, no path), the network node 110 determines whether the object is occluded by as yet unassigned objects (block 550). If the object is occluded by an unassigned object (block 550, yes path), the object is not assigned to the current layer, though the object remains unassigned as the object may yet be assigned to a lower layer (i.e., if the object is not fully-occluded).

If the object is not occluded by an unassigned object (block 550, no path), the network node 110 determines whether a bounding box of the object overlaps with the bounding box of any other object in the layer (e.g., within a given margin) (block 560). If the bounding boxes are considered to be overlapping (block 560, yes path), the object is not assigned to the current layer, though the object remains unassigned as the object may yet be assigned to a lower layer (i.e., if the object is not fully-occluded).

If the bounding boxes are considered to be disjoint (block 560, no path), the object is assigned to the current layer (block 570). In this regard, the network node 110 may maintain a list of the objects added to this layer (e.g., for later use in encoding each layer into a separate video stream). Having assigned the object to the current layer, the object is removed from the list of unassigned objects. Responsive to having assigned the object to the current layer, the network node 110 then identifies the occluded and non-occluded parts of the object's bounding box and fills any non-occluded parts with alpha (i.e., transparency).

In some embodiments, identifying the occluded and non-occluded parts may comprise adding some margin to support scenarios in which an object is occluded but may become non-occluded due to warping performed by the computing device 120. To support such scenarios, some embodiments reduce the occluded part of the object by a given margin so that more of the object than is actually visible can be streamed to the computing device 120. By requiring the bounding boxes of the objects in the same layer to be disjoint (after allotting for a margin, if any), the computing device 110 may be enabled to perform space warping on a per object basis without distorting other image parts.

Although not shown in FIG. 6, it should be noted that this method 500 of determining which objects to assign to a given layer may be repeated for successively lower layers until each of the objects in the 3D scene is either assigned to one of the layers or determined to be occluded and not included in any of the layers. For this purpose, objects that remain in the unassigned object list after all of the objects have been considered may be mapped to a lower layer (e.g., a higher layer number) in a subsequent cycle.

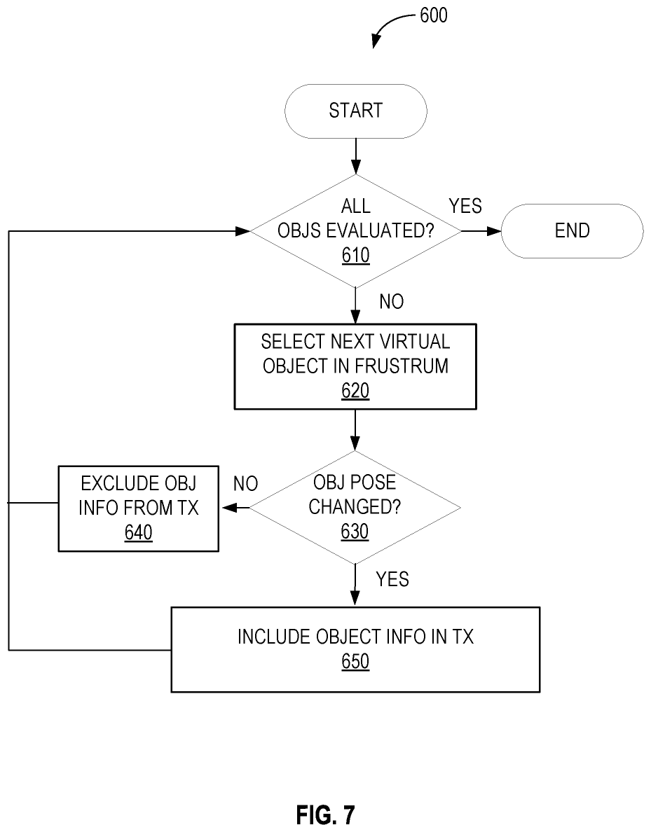

As discussed above, the network device 110 determines what information to send over the lower latency channel 250. FIG. 7 is a flow diagram illustrating an example method 600, implemented by a network device 110, of determining information to transmit on the lower latency channel 250. The method 600 may, for example, be invoked in response to receiving a scene update notification, as discussed above with respect to FIG. 4.

The method 600 iterates through each virtual object within the viewing frustrum (block 610, no path). Once all of the objects within the viewing frustrum have been evaluated for having their information either included or excluded from the transmission, the method 600 ends (block 610, yes path).

In response to the network device 110 having not yet evaluated all of the virtual objects in the viewing frustrum, the network device 110 selects the next virtual object in the frustrum to be considered (block 620) and determines whether the object's pose has changed (e.g., since the last time the network device 110 sent pose information for that object) (block 630). If the object's pose has not since changed (block 630, no path), the network node excludes information about the object from the transmission (block 640). If the object's pose has since changed (block 630, yes path), the network node include information about the object in the transmission (block 650). Such object information may include, e.g., an object identifier, object pose information, object speed, and/or object acceleration, among other things.

After the method 600 has completed, the information about the included objects may be transmitted to the computing device 120 over the lower latency channel 250 as discussed above (e.g., with respect to FIG. 4, element 370).

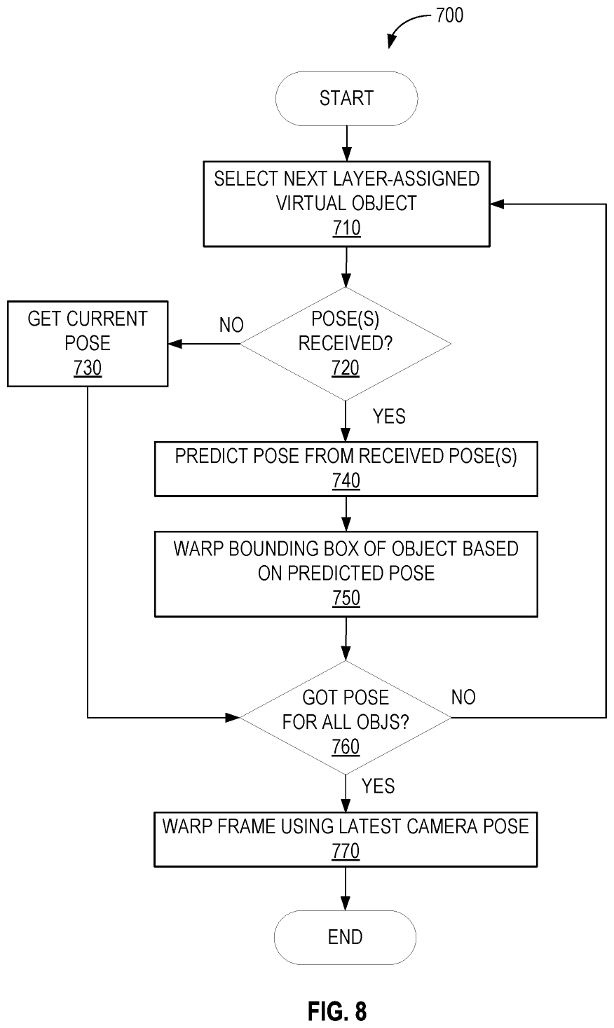

FIG. 8 is a flow chart illustrating an example method 700, implemented by a computing device 120, of warping using the video data and object information respectively received over the higher latency channel 240 and the lower latency channel 250 (e.g., in response to sending a scene update notification to the network device 110). To begin, the computing device 120 selects virtual object that has been assigned to a layer (block 710). As will be shown below, the method 700 will iterate through each of the layer-assigned virtual objects.

The computing device 120 then determines whether one or more poses have been received for the selected virtual object via the lower latency channel 250 (block 720). In general, whether or not a pose is received for a given virtual object will depend respectively on whether or not the object has moved. If no pose has been received for the object (block 720, no path), the computing device 120 will retrieve a current pose for the object (e.g., from the current frame) (block 730). Otherwise (block 720, yes path), the computing device 120 predicts a new pose from the one or more poses received (block 740) and warps the bounding box of the object based on the predicted pose (block 750).

The computing device 120 then determines whether poses have been obtained for all of the virtual objects assigned to layers (e.g., either by predicting a new pose or obtaining the current pose) (block 760). If not (block 760, no path), the computing device 120 will continue to iterate through the layer-assigned virtual objects. If a pose has been obtained for each layer-assigned virtual object (block 760, yes path), then the computing device 120 adjusts the image to the pose of the camera, e.g., by warping the frame as a whole.

It will be appreciated that the various non-limiting embodiments discussed above are all compatible with one another. That said, it should also be appreciated that although many of the features may be advantageous in numerous scenarios, not every feature described above is a necessary element of the invention.

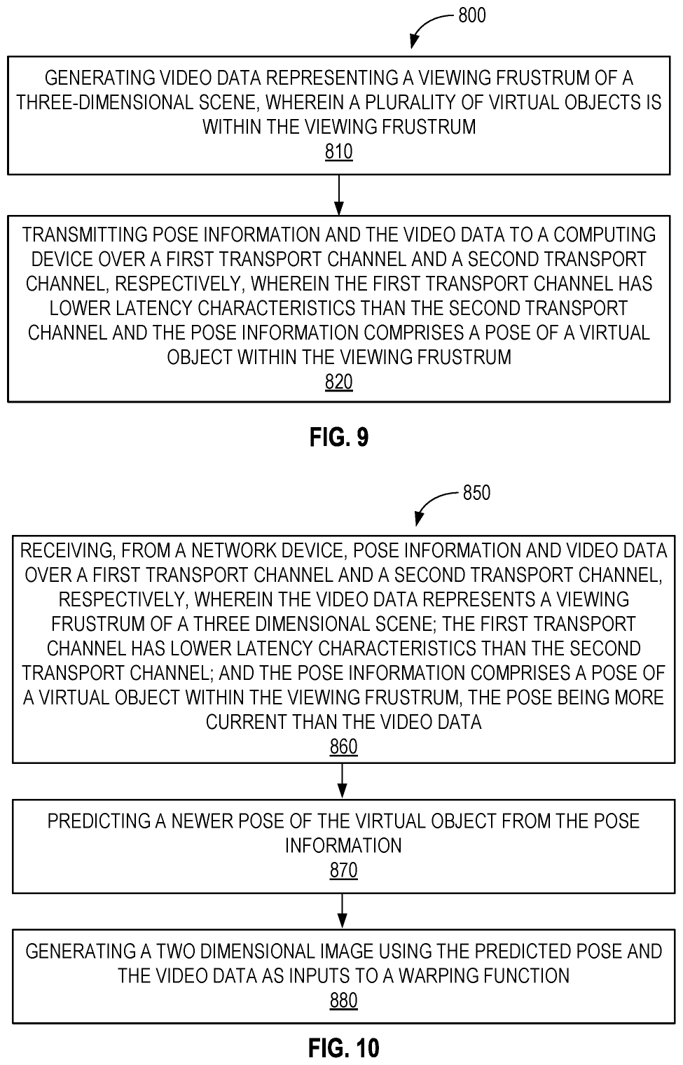

Accordingly, FIG. 9 illustrates a method 800, implemented by a network device 110, in accordance with one or more embodiments of the present disclosure. The method 800 comprises generating video data representing a viewing frustrum of a three-dimensional scene (block 810). A plurality of virtual objects is within the viewing frustrum. The method 800 further comprises transmitting pose information and the video data to a computing device 120 over a first transport channel 130a and a second transport channel 130b, respectively (block 820). The first transport channel 130a has lower latency characteristics than the second transport channel 130b and the pose information comprises a pose of a virtual object within the viewing frustrum.

Correspondingly, FIG. 10 illustrates a method 850, implemented by a computing device 120, according to one or more embodiments of the present disclosure. The method 850 comprises receiving, from a network device 110, pose information and video data over a first transport channel 130a and a second transport channel 130b, respectively (block 860). The video data represents a viewing frustrum of a three-dimensional scene. The first transport channel 130a has lower latency characteristics than the second transport channel 130b. The pose information comprises a pose of a virtual object within the viewing frustrum, the pose being more current than the video data. The method 850 further comprises predicting a newer pose of the virtual object from the pose information (block 870) and generating a two-dimensional image using the predicted pose and the video data as inputs to a warping function (block 880).

Other embodiments include appropriate computing hardware configured to perform one or more of the methods described above. For example, embodiments of the present disclosure include a network device 110 as schematically illustrated in FIG. 11. The network device 110 of FIG. 11 comprises processing circuitry 910a and interface circuitry 930a. In some embodiments, the network device 110 further comprises memory circuitry 920a. The processing circuitry 910a is communicatively coupled to the memory circuitry 920a and the interface circuitry 930a, e.g., via one or more buses.

The processing circuitry 910a may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 910a may be programmable hardware capable of executing software instructions stored, e.g., as a machine-readable computer program 940a in the memory circuitry 920a. Execution of the software instructions may configure the processing circuitry 910a to perform one or more of the methods described herein with respect to the network device 110.

The memory circuitry 920a may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 930a may be a controller hub configured to control the input and output (I/O) data paths of the network device 110. Such I/O data paths may include data paths for exchanging signals over a network. For example, the interface circuitry 930a may comprise a transceiver configured to send and receive communication signals over the network. The interface circuitry 930a may be implemented as a unitary physical component or as a plurality of physical components that are contiguously or separately arranged, any of which may be communicatively coupled to any other or may communicate with any other via the processing circuitry 910a. For example, the interface circuitry 930a may comprise output circuitry (e.g., transmitter circuitry configured to send communication signals over the network) and input circuitry (e.g., receiver circuitry configured to receive communication signals over the network). According to embodiments of the hardware illustrated in FIG. 11, the processing circuitry 910a is configured to generate video data representing a viewing frustrum of a three-dimensional scene. A plurality of virtual objects is within the viewing frustrum. The processing circuitry 910a is further configured to transmit pose information and the video data to a computing device 120 over a first transport channel 130a and a second transport channel 130b, respectively. The first transport channel 130a has lower latency characteristics than the second transport channel 130b and the pose information comprises a pose of a virtual object within the viewing frustrum.

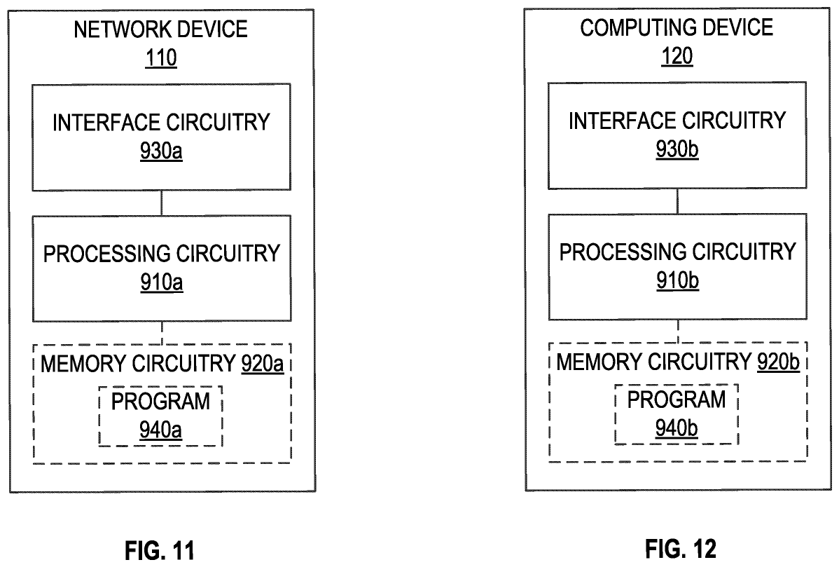

Other embodiments of the present disclosure include a computing device 120 as schematically illustrated in FIG. 12. The computing device 120 of FIG. 12 comprises processing circuitry 910b and interface circuitry 930b. In some embodiments, the computing device 120 further comprises memory circuitry 920b. The processing circuitry 910b is communicatively coupled to the memory circuitry 920b and the interface circuitry 930b, e.g., via one or more buses.

The processing circuitry 910b may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 910b may be programmable hardware capable of executing software instructions stored, e.g., as a machine-readable computer program 940b in the memory circuitry 920b. Execution of the software instructions may configure the processing circuitry 910b to perform one or more of the methods described herein with respect to the computing device 120.

The memory circuitry 920b may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 930b may be a controller hub configured to control the input and output (I/O) data paths of the computing device 120. Such I/O data paths may include data paths for exchanging signals over a network. For example, the interface circuitry 930b may comprise a transceiver configured to send and receive communication signals over the network. The interface circuitry 930b may be implemented as a unitary physical component, or as a plurality of physical components that are contiguously or separately arranged, any of which may be communicatively coupled to any other or may communicate with any other via the processing circuitry 910b. For example, the interface circuitry 930b may comprise output circuitry (e.g., transmitter circuitry configured to send communication signals over the network) and input circuitry (e.g., receiver circuitry configured to receive communication signals over the network).

According to embodiments of the hardware illustrated in FIG. 12, the processing circuitry 910b is configured to receive, from a network device 110, pose information and video data over a first transport channel 130a and a second transport channel 130b, respectively. The video data represents a viewing frustrum of a three-dimensional scene. The first transport channel 130a has lower latency characteristics than the second transport channel 130b. The pose information comprises a pose of a virtual object within the viewing frustrum, the pose being more current than the video data. The processing circuitry 910b is further configured to predict a newer pose of the virtual object from the pose information and generate a two-dimensional image using the predicted pose and the video data as inputs to a warping function.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-25. (canceled)

26. A method of supporting cloud-based rendering, implemented by a network device, the method comprising:
generating video data representing a viewing frustrum of a three-dimensional scene, wherein a plurality of virtual objects is within the viewing frustrum;
transmitting pose information and the video data to a computing device over a first transport channel and a second transport channel, respectively, wherein the first transport channel has lower latency characteristics than the second transport channel and the pose information comprises a pose of a virtual object within the viewing frustrum.

27. The method of claim 26, wherein transmitting the pose information comprises transmitting the pose of the virtual object after transmitting the video data such that the pose of the virtual object is more current than the video data upon arrival at the computing device.

28. The method of claim 27, wherein:
transmitting the pose information further comprises transmitting, before the pose of the virtual object, an earlier pose of the virtual object; and
the earlier pose and pose of the virtual object correspond to motion of the virtual object within the viewing frustrum.

29. The method of claim 26, wherein the generating and transmitting is responsive to receiving a scene update notification from the computing device.

30. The method of claim 26, wherein the virtual object occludes an occluded virtual object that is within the viewing frustrum and the method comprises excluding the occluded virtual object from the pose information transmitted to the computing device.

31. The method of claim 30, further comprising:
determining that the virtual object and the occluded virtual object mutually occlude each other;
assigning a non-cyclic object occlusion relationship to the virtual object and occluded virtual object, the non-cyclic object occlusion relationship designating the virtual object as occluding the occluded virtual object without the occluded virtual object occluding the virtual object; and
excluding the occluded virtual object from the pose information in response to assigning the non-cyclic object occlusion relationship.

32. The method of claim 26, wherein:
the pose information further comprises a further virtual object within the viewing frustrum;
the method further comprises assigning the virtual object and the further virtual object to different layers of the video data; and
generating the video data comprises generating a respective video stream for each of the different layers.

33. The method of claim 32, further comprising assigning an additional virtual object within the viewing frustrum to a same layer as the virtual object responsive to the virtual object and the additional virtual object having disjoint bounding boxes.

34. The method of claim 26, wherein the pose information further comprises a camera pose corresponding to the viewing frustrum.

35. The method of claim 26, further comprising transmitting a speed and/or acceleration of the virtual object over the first transport channel.

36. The method of claim 26, further comprising including the pose of the virtual object in the pose information responsive to determining that the pose of the virtual object has changed.

37. The method of claim 26, further comprising excluding a pose of a non-moving virtual object within the viewing frustrum from the pose information.

38. A method of generating a two-dimensional image of a three-dimensional scene, implemented by a computing device, the method comprising:
receiving, from a network device, pose information and video data over a first transport channel and a second transport channel, respectively, wherein:
the video data represents a viewing frustrum of a three-dimensional scene;
the first transport channel has lower latency characteristics than the second transport channel; and
the pose information comprises a pose of a virtual object within the viewing frustrum, the pose being more current than the video data; and
predicting a newer pose of the virtual object from the pose information;
generating a two-dimensional image using the predicted pose and the video data as inputs to a warping function.

39. The method of claim 38, wherein generating the two-dimensional image using the predicted pose and the video data as inputs to the warping function comprises warping a bounding box of the virtual object based on the predicted newer pose.

40. The method of claim 38, wherein:
the video data comprises a plurality of video streams, each video stream corresponding to a respective layer of the scene; and
the virtual object and a further virtual object within the viewing frustrum are assigned to different layers of the scene.

41. The method of claim 40, further comprising using a pose of the further virtual object to generate:
an earlier two-dimensional image of the scene before receiving the pose information and the video data;
along with the pose information and the video data, the two-dimensional image of the scene in response to the further virtual object remaining stationary since generating the earlier two-dimensional scene.

42. The method of claim 40, wherein generating the two-dimensional image further comprises warping an image frame comprising the virtual object and the further virtual object based on a camera pose corresponding to the viewing frustrum.

43. A network device comprising:
processing circuitry and interface circuitry communicatively connected to the processing circuitry, wherein the processing circuitry is configured to:
generate video data representing a viewing frustrum of a three-dimensional scene, wherein a plurality of virtual objects is within the viewing frustrum;
transmit pose information and the video data to a computing device via the interface circuitry over a first transport channel and a second transport channel, respectively, wherein the first transport channel has lower latency characteristics than the second transport channel and the pose information comprises a pose of a virtual object within the viewing frustrum.

44. A computing device comprising:
processing circuitry and interface circuitry communicatively connected to the processing circuitry, wherein the processing circuitry is configured to:
receive, from a network device, pose information and video data over a first transport channel and a second transport channel, respectively, wherein:
the video data represents a viewing frustrum of a three-dimensional scene;
the first transport channel has lower latency characteristics than the second transport channel; and
the pose information comprises a pose of a virtual object within the viewing frustrum, the pose being more current than the video data; and
predict a newer pose of the virtual object from the pose information;
generate a two-dimensional image using the predicted pose and the video data as inputs to a warping function.
